(19) United States
(12) Patent Application Publication
(10) Pub. No.: US 2015/0042089 A1
(43) Pub. Date: Feb. 12, 2015

(54) HIGH PRESSURE FITTING FOR A LIQUID CHROMATOGRAPHY SYSTEM

(71) Applicant: Waters Technologies Corporation, Milford, MA (US)

(72) Inventors: Kurt D. Joudrey, Chelmsford, MA (US); Sylvain Cormier, Mendon, MA (US); James Usowicz, Webster, MA (US); Emily J. Berg, Milford, MA (US); Christopher Seith, Franklin, MA (US)

(21) Appl. No.: 14/382,850

(22) PCT Filed: Feb. 1, 2013
(86) PCT No.: PCT/US13/24347

§ 371 Date: Sep. 4, 2014

Related U.S. Application Data
(60) Provisional application No. 61/607,034, filed on Mar. 6, 2012.

(51) Int. Cl. F16L 19/06; G01N 30/60

(52) U.S. Cl. CPC F16L 19/061; G01N 30/6026
USPC 285/343

(57) ABSTRACT

A fitting for coupling fluidic paths, such as high pressure fluidic paths in liquid chromatography systems, includes a compression nut, a tube assembly and a compression member. The compression nut has a threaded outer surface to engage a threaded bore of a receiving port and the tube assembly has an outer surface and an end face to contact a sealing surface of the receiving port. The compression member is pre-staked to the outer surface of the tube assembly at a predetermined distance from the end face and has a tapered surface to engage a surface of the receiving port. The predetermined distance permits the tube assembly to be inserted into the receiving port so that the end face makes contact with the sealing surface without the tapered surface engaging a surface of the receiving port and so that the threaded outer surface of the compression nut engages the threaded bore.

### RELATED APPLICATION

This application claims the benefit of the earlier filing date of U.S. Provisional Patent Application Ser. No. 61/607,034, filed Mar. 6, 2012 and titled “High Pressure Fitting for a Liquid Chromatography System,” the entirety of which is incorporated herein by reference.

### FIELD OF THE INVENTION

The invention relates generally to fluidic couplings for high pressure fluidic systems. More particularly, the invention relates to a device and a method for coupling high pressure fluidic paths in liquid chromatography systems.

### BACKGROUND

Chromatography is a set of techniques for separating a mixture into its constituents. Well-established separation technologies include HPLC (High Performance Liquid Chromatography), UPLC (Ultra Performance Liquid Chromatography) and SFC (Supercritical Fluid Chromatography). HPLC systems use high pressure, ranging traditionally between 1,000 psi (pounds per square inch) to approximately 6,000 psi, to generate the flow required for liquid chromatography (LC) in packed columns. In contrast to HPLC, UPLC systems use columns with smaller particulate matter and higher pressures approaching 20,000 psi to deliver the mobile phase. SFC systems use highly compressible mobile phases, which typically employ carbon dioxide (CO₂) as a principle component.

In a typical LC system, a solvent delivery system takes in and delivers a mixture of liquid solvents to an autosampler (also called an injection system or sample manager), where an injected sample awaits the arrival of this mobile phase. The mobile phase carries the sample through a separating column. In the column, the mixture of the sample and mobile phase divides into bands depending upon the interaction of the mixture with the stationary phase in the column. A detector identifies and quantifies these bands as they exit the column.

High pressure fittings used in liquid chromatography systems typically include a ferrule and a compression nut to couple a tube to a receiving port of a component of the system. If a high pressure fitting is not properly installed, a gap may be present between the end of the tube and the bottom of the receiving port. The gap can result in an increased corrosion rate. In addition, an unswept volume between the bottom of the receiving port and the location of the seal achieved along the ferrule can exist. Fluid in the unswept volume is not flushed out by fluid flow and can remain trapped. Thus, if the fitting resides in the flow path at or beyond where sample is introduced into the LC system, the unswept volume can result in carryover, band spreading and mixer noise, all of which can degrade chromatographic measurements.

### SUMMARY

In one aspect, the invention features a fitting for coupling fluidic paths. The fitting includes a compression nut, a tube assembly and a compression member. The compression nut has a threaded outer surface to engage a threaded bore of a receiving port and the tube assembly has an outer surface and an end face to contact a sealing surface of the receiving port. The compression member is pre-staked to the outer surface of the tube assembly at a predetermined distance from the end face and has a tapered surface to engage a surface of the receiving port. The predetermined distance permits the tube assembly to be inserted into the receiving port so that the end face makes contact with the sealing surface without the tapered surface engaging a surface of the receiving port and so that the threaded outer surface of the compression nut engages the threaded bore of the receiving port.

In another aspect, the invention features a method for coupling fluidic paths. A tube is inserted through a compression nut having a threaded outer surface and through a compression member having a tapered surface. The compression member is pre-staked at an initial position on an outer surface of the tube assembly at a predetermined distance from an endface of the tube assembly. The tube assembly is inserted into a receiving port having a threaded outer bore, an inner bore to receive the tube assembly, a cavity having a tapered surface and extending from an end of the outer bore to a first end of the inner bore, a sealing surface at a second end of the inner bore and a fluid channel extending from the sealing surface to conduct a fluid passing through the tube assembly. The compression nut is threaded into the threaded outer bore of the receiving port so that the compression nut engages the compression member at the initial position and urges the tube into the inner bore so that the endface is in contact with the abutment surface. On further threading of the compression nut, the compression nut urges the compression member along the outer surface of the tube assembly from the initial position until the tapered surface of the compression member is in contact with the tapered surface of the cavity.

In yet another aspect, the invention features a fixture for pre-staking a compression member to a tube assembly. The fixture includes a threaded upper bore, a middle bore, a conical cavity extending between the threaded upper bore and the middle bore, and a lower bore extending from an end of the middle bore opposite to the conical cavity, the middle bore having a length to maintain a predetermined distance from an end face of a tube assembly inserted into the lower bore to a compression member on an outer surface of the tube assembly. Rotation of a compression nut having a threaded outer surface engaged with the threaded upper bore applies a controlled force to pre-stake the compression member to maintain the predetermined distance from the end face of the tube assembly to the compression member.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a block diagram of an embodiment of a liquid chromatography system.

FIG. 2 is a functional diagram of an embodiment of a sample manager of a liquid chromatography system.

FIG. 3 is a side view of an embodiment of a fitting for coupling two fluidic paths.

FIG. 4 is an illustration of an embodiment of a coupling of tubing to a stator portion of a rotary shear seal valve through a fitting.

FIG. 5 is a detailed cross-sectional view of the fitting of FIG. 3 used to couple a fluid path in a tube to a fluid channel at a receiving port.

FIG. 6 is a detailed cross-sectional view of an improperly installation of the fitting of FIG. 3 in a receiving port.

FIG. 7A and FIG. 7B are illustrations of the fitting of FIG. 3 without the back portion of the compression member and without the compression nut. FIG. 7A and FIG. 7B correspond to the proper and improper fitting installations of FIG. 5 and FIG. 6, respectively.

FIG. 8 is an illustration of an embodiment of a fixture for pre-staking a compression member to the sleeve of a tube assembly.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

High pressure fittings used in chromatographic systems typically include a compression member (e.g., a ferrule) and a compression nut to couple a fluid path in a tube to a fluid channel in a structure that includes a receiving port to receive the fitting. During installation, the installer slides the compression nut onto the tube and then slides the ferrule onto the tube before inserting the tube into the receiving port. The compression nut is tightened while the installer maintains a force on the tube to keep the endface of the tube in contact with a sealing surface at the bottom of the receiving port. The installer needs to know the proper installation technique. If installed improperly, there can be a gap between the end of the tube and the sealing surface of the receiving port. The gap can lead to an increased corrosion rate for the fitting and chromatographic problems such as carryover, band spreading and mixer noise.

In brief overview, the invention relates to a fitting for coupling fluidic paths, including high pressure fluidic paths such as those included in HPLC, UPLC and SFC systems. The fitting includes a compression nut and a compression member that is pre-staked to an outer surface of a tube assembly at a predetermined distance from an end face of a tube. The pre-staking is performed using a force sufficient to secure the compression member to withstand unintentional displacement of the compression member along the tube assembly during insertion of the tube assembly into a receiving port. The pre-staking force is not so great as to prevent movement of the compression member along the tube assembly during rotation of the compression nut to complete the installation procedure. The pre-staking position of the compression member is selected (i.e., determined) to ensure that the end face of the tube is in contact with a sealing surface of the receiving port while allowing the threads of the compression nut to engage the threaded bore of the receiving port. Advantageously, the creation of an unswept volume within the fitting that can result from improper installation is eliminated. Thus carryover, bandspreading and mixer noise which can result from an unswept volume and degrade chromatographic measurements are avoided.

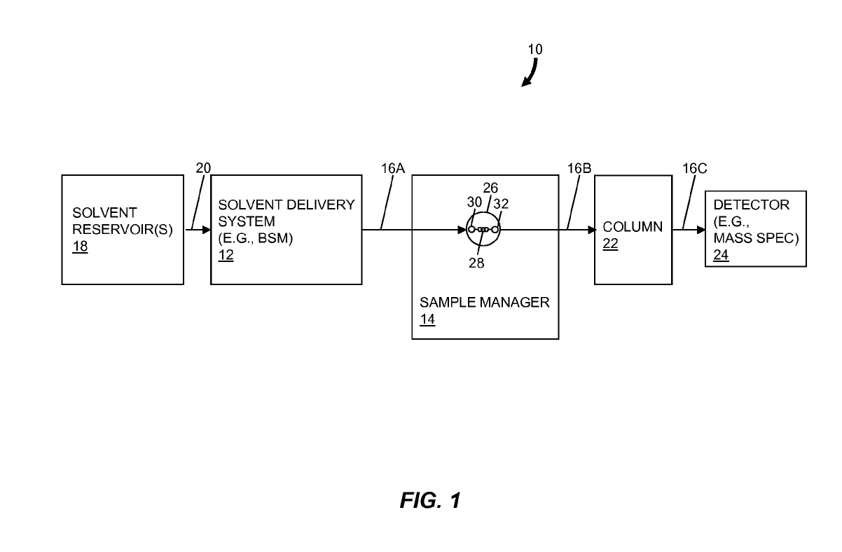

FIG. 1 shows an embodiment of a liquid chromatography system 10 for separating a sample into its constituents. The liquid chromatography system 10 can be an HPLC, UPLC, or SFC system. The liquid chromatography system 10 includes a solvent delivery system 12 in fluidic communication with a sample manager 14 (also called an injector or autosampler) through tubing 16A. The solvent delivery system 12 includes pumps (not shown) in fluidic communication with solvent (or fluid) reservoirs 18 from which the pumps draw solvents through tubing 20. A chromatography column 22 is in fluidic communication with the sample manager 14 through tubing 16B. Tubing 16C couples the output port of the column 22 to a detector 24, for example, a mass spectrometer. Through the tubing 16C, the detector 24 receives the separated components from the column 22 and produces an output from which the identity and quantity of the analytes may be determined As described herein, at various locations in the liquid chromatography system 10, the tubing 16A, 16B, 16C (generally 16) is coupled to system components using high pressure fittings. Each tubing 16 refers to a section of tubing rather a single tube, for each tubing section may comprise one tube or multiple tubes joined in series (e.g., by valves, tees, etc).

The sample manager 14 includes an injector valve 26 with a sample loop 28. The solvent manager 14 operates in one of two states: a load state and an injection state. In the load state, the position of the injector valve 26 is such that the solvent manager 14 loads the sample into the sample loop 28; in the injection state, the position of the injector valve 26 changes so that solvent manager 14 introduces the sample in the sample loop 28 into the continuously flowing mobile phase arriving from the solvent delivery system 12. With the injector valve 26 in the injection state, the mobile phase carries the sample into the column 22, the mobile phase arriving at the injector valve 26 through an input port 30 and leaving with the sample through an output port 32.

Various fittings according to principles of the invention as described below may be present within the liquid chromatography system 10. For example, such fittings may be present where the tubing 16A connects to the input port 30 of the injector valve 26, where the tubing 16B connects to the output port 32 of the injector valve 26 and to the column 22, and where the tubing 16C connects to the output end of the column 22 and to the detector 24.

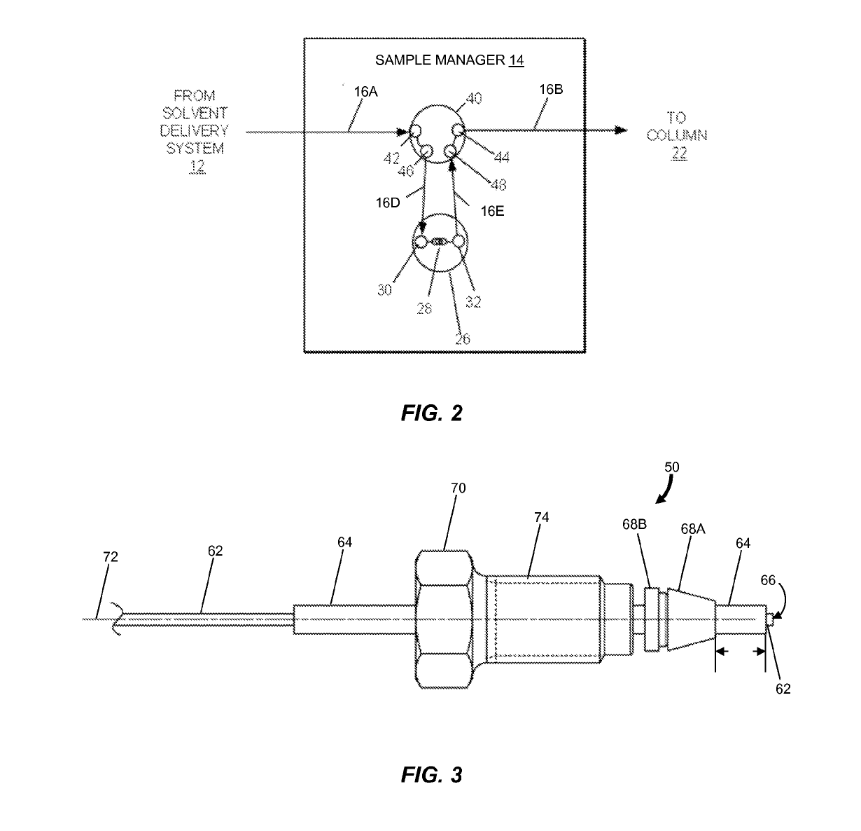

As shown in FIG. 2, in some embodiments, for example, those in which the liquid chromatography system 10 is a CO₂-based system, the sample manager 14 can further include an auxiliary valve 40 interposed between the solvent delivery system 12 and the injector valve 26 and between the injector valve 26 and the column 22. In general, the auxiliary valve 40 provides a fluidic pathway through which the injector valve 26 may vent. In this embodiment, the tubing 16A couples the solvent delivery system 12 to a first input port 42 of the auxiliary valve 40 and the tubing 16B couples a second output port 44 of the auxiliary valve 40 to the column 22. Tubing 16D and 16E also couple the auxiliary valve 40 to the injector valve 26; tubing 16D connects a first output port 46 of the auxiliary valve 40 to the input port 30 of the injector valve 26, and tubing 16E connects the output port 32 of the injector valve 26 to a second input port 48 of the auxiliary valve 40.

When the valves 26, 40 are configured for sample injection, the arrows on the tubing 16A and 16D show the direction of flow of the mobile phase towards the injector valve 26; those arrows on the tubing 16E and 16B correspond to the flow of the mobile phase carrying the sample from the injector valve 26 towards the column 22.

Like the tubing 16 described in connection with FIG. 1, the additional tubing 16D and 16E can also be coupled at their ends with fittings configured according to principles of the invention. More specifically, such fittings may be present where the tubing 16D connects to the first output port 46 of the auxiliary valve 40 and to the input port 30 of the injector valve 26, and where the tubing 16E connects to the output port 32 of the injector valve 26 and to the second input port 48 of the auxiliary valve 40.

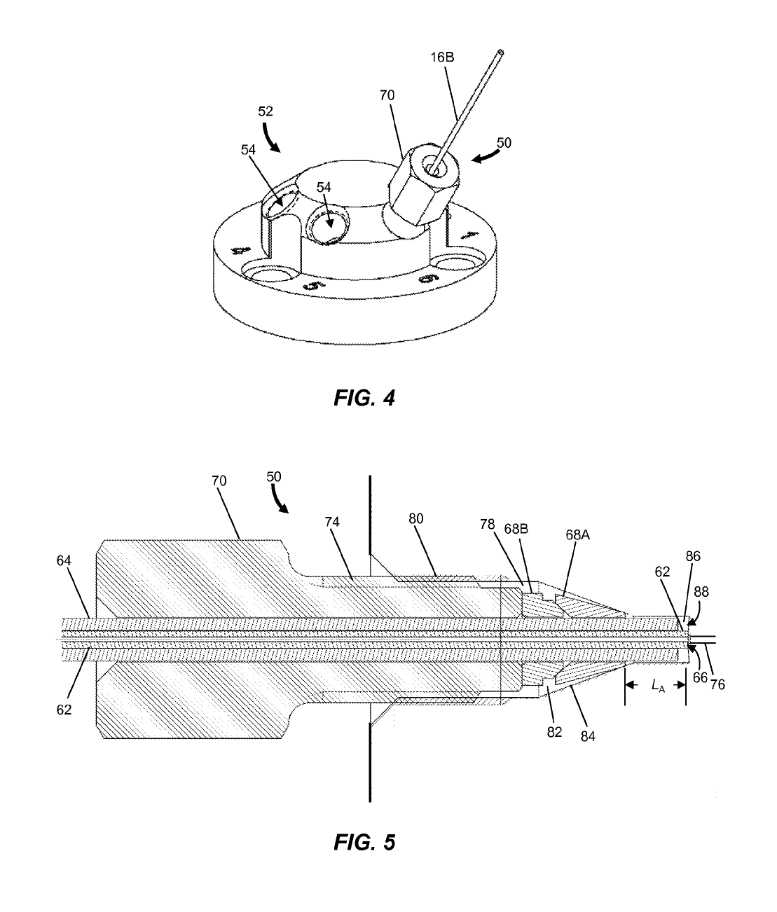

FIG. 3 shows an embodiment of a fitting 50 for coupling two fluidic paths, for example, to couple any of the tubing 16 of FIG. 1 and FIG. 2 to an internal fluidic path in a rotary shear seal valve. FIG. 4 shows an example of how the fitting 50 is used to couple the tubing 16B to the stator portion 52 of a rotary shear seal valve through one of the receiving ports 54. Only one fitting connection is shown for clarity although it will be recognized that other tubing 16 may be coupled to other receiving ports 54 of the stator portion 52 in a similar manner. The fitting 50 includes a tube assembly having a tube 62 surrounded by a sleeve 64. Either or both the tube 62 and the sleeve 64 can be made of stainless steel. One or more welds may join the tube 62 to the sleeve 64. As an example, the inner diameter (ID) and outer diameter (OD) of the tube 62 can be 0.007 in. and 0.025 in., respectively, and the OD of the sleeve 64 can be 0.062 in. The end face 66 of the tube 62 is substantially normal to the longitudinal axis 72 of the tube 62 and has a low surface roughness. In the illustrated embodiment, a portion of the tube 62 that includes the end face 66 protrudes from the end of the sleeve 64. The length (e.g., 0.015 in.) of the protrusion allows the end face 66 of the tube 62 to contact a sealing surface of a receiving port of a system component (e.g., the injector valve 26). In alternative embodiments the tube 66 does not extend out of the sleeve 64 or a tube without a sleeve (e.g., a tube having an OD of 0.062) may be used.

The fitting 50 further includes a two-part compression member 68A and 68B (generally 68) and a compression nut 70. Both the compression member 68 and the compression nut 70 have an axial bore to pass the tube assembly. The two-part compression member 68 includes a front portion 68A having a tapered or conical outer surface and a back portion 68B. The compression member 68 can be, for example, a stainless steel ferrule set (e.g., part no. SS-100-SET available from Swagelok Company of Solon, Ohio). The compression nut 70 has threads 74 for engaging threads of the receiving port.

FIG. 5 shows a detailed cross-sectional view of the fitting 50 of FIG. 3 used to couple the fluid path within the tube 62 to a fluid channel 76 extending from the receiving port. The receiving port includes an outer bore 78 having a threaded wall 80 to engage the threads 74 of the compression nut 70, a cavity 82 defined within a tapered surface (e.g., conical surface) 84, and an inner bore 86 having a sealing surface 88 at an end furthest from the cavity 82. Proper coupling is achieved with the end face 66 of the tube 62 flush with the sealing surface 88 of the receiving port.

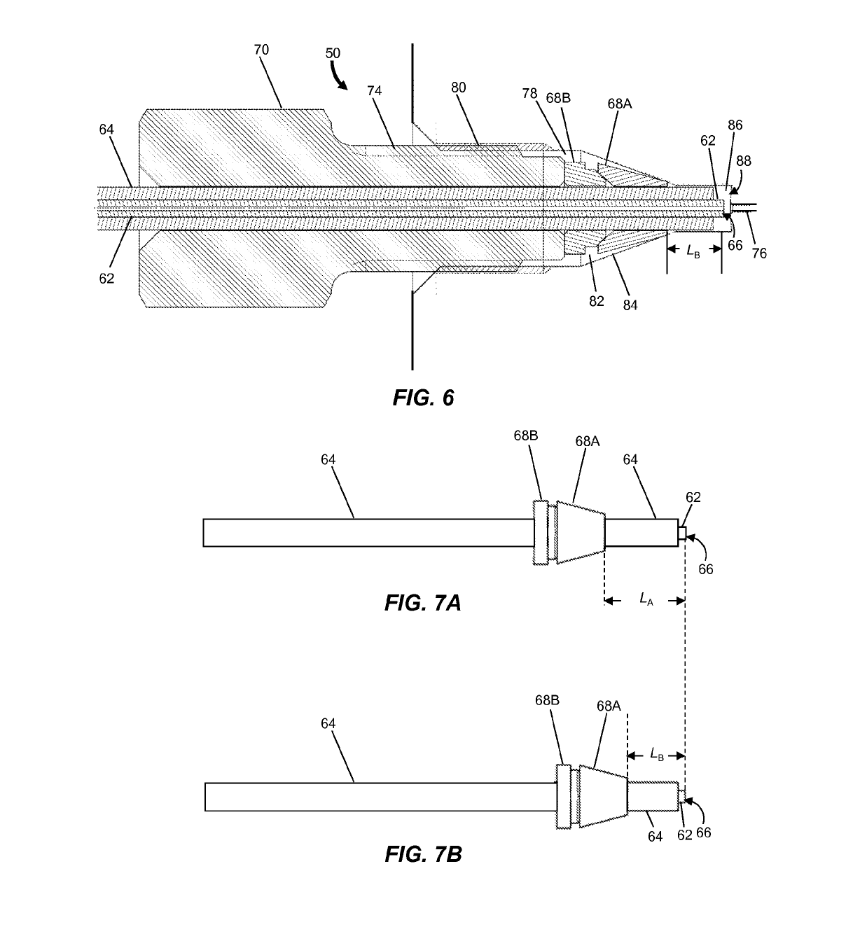

FIG. 6 illustrates a coupling where the fitting 50 has been improperly installed. The result is a gap between the end face 66 of the tube 62 and the sealing surface 88. Consequently, a portion of the inner bore 86 that is not occupied by the tube 62 and sleeve 64 may be filled by fluid. The filled portion is an unswept volume that can result in carryover, band spreading and mixer noise, all of which can degrade chromatographic measurements. Moreover, the unswept volume can lead to an increased corrosion rate at the fitting 50.

FIG. 7A and FIG. 7B illustrate the fitting 50 without the compression nut 70 for the proper and improper installations of FIG. 5 and FIG. 6, respectively. The separation L_{A} between the narrow end of the front portion 68A of the compression member 68 and the end face 66 as shown in FIG. 7A allows the end face 66 to be maintained in contact with the sealing surface 88 when the tapered surface of the front portion 68A is in contact with the tapered surface 84 of the cavity 82. In contrast, when the tapered surface of the front portion 68A is in contact with the tapered surface 84 of the cavity 82 as shown by the example of FIG. 6, the separation L_{B} between the narrow end of the front portion 68A and the end face 66 results in the gap between the end face 66 and the sealing surface 88, and therefore an unswept volume exists within the fitting 50.

In various embodiments of a method for coupling fluidic paths according to the invention, the front portion 68A of the compression member 68 is pre-staked at a position along the sleeve 64 to ensure that the subsequent installation process for the fitting 50 will result in a proper seal of the end face 66 to the sealing surface 88. This is accomplished by pre-staking the front portion 68A at a predetermined distance L from the end face 66. The predetermined distance L is at least as great at the distance L_{A} shown for proper final installation according to FIG. 7A. This pre-staking distance L is preferably greater than the distance L_{A} and is selected so that only a few turns of the compression nut 70 are necessary for finishing the installation. Moreover, the pre-staking distance L should not be so great as to prevent the threads 74 of the compression nut 70 from engaging the threads 80 of the outer bore 78 of the receiving port when the compression nut 70 urges the back portion 68B of the compression member 68 to first come into contact with the front portion 68A of the compression member 68.

The force used to pre-stake is sufficient to prevent an installer from inadvertently moving the front portion 68A of the compression member 68 when the tube assembly is inserted into the receiving port. However, the pre-staking force is not so great as to allow the front portion 68A of the compression member 68 to resist the force applied to it when the compression nut 70 is subsequently rotated during the installation process. Thus the front portion 68A is moved from its pre-staked position to a final position as shown in FIG. 5 and FIG. 7A with proper rotation of the compression nut 70 without risk of a gap between the end face 66 of the tube 62 and the sealing surface 88 of the receiving port.

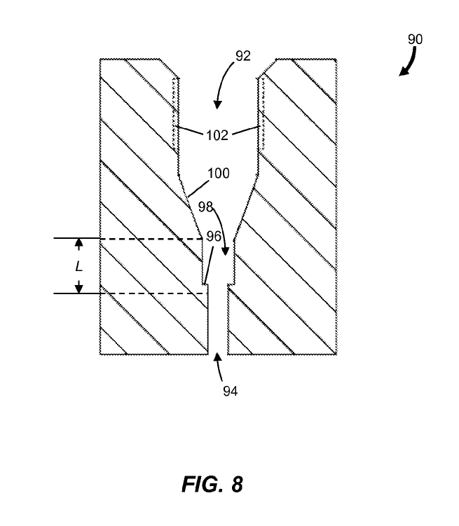

Reference is now made to FIG. 5 and also to FIG. 8 which shows a fixture 90 that can be used to quickly and accurately pre-stake the front portion 68A of the compression member 68 to the sleeve 64. First, the tube assembly 60 is passed through the compression nut 70 and then through the back portion 68B and front portion 68A of the compression member 68 before being inserted through an upper bore 92 and into a middle bore 98 of the fixture 90. The end face 66 of the tube 62 will extend into a lower bore 94 of the fixture 90 while the end of the sleeve 64 rests against the surface 96 at the bottom of the middle bore 98. The front portion 68A of the compression member 68 is free to slide down the sleeve 64 until it makes contact with the tapered surface 100 of the fixture 90. This process establishes the desired separation L between the front portion 68A of the compression member 68 and the end face 66 of the tube 62. The threads 74 of the compression nut 70 engage the threaded wall 102 surrounding the cavity 92. The compression nut 70 is rotated until finger tight and then by an additional amount (e.g., one quarter of a turn) to lightly secure (i.e., pre-stake) the front portion 68A to the sleeve 64 to maintain the desired separation L. The components of the fitting 50 are then removed from the fixture 90 and are available for installation in a receiving port as described above. The fixture can be configured alternatively so that a different part of the front portion 68A, such as the middle or rear, is pre-staked to the sleeve 64 to prevent “plowing” of the front portion 68A.

In other embodiments, the fixture can be configured without the lower bore 94 so that the end face 66 of the tube 62 comes into contact with surface 96 and the length L is modified accordingly. These embodiments are useful when the tube 62 does not protrude from the sleeve 64 or when there is no sleeve over the tube 62.

While the invention has been shown and described with reference to specific embodiments, it should be understood by those skilled in the art that various changes in form and detail may be made therein without departing from the spirit and scope of the invention as recited in the accompanying claims. For example, the embodiments above relate generally to a two-part compression member; however, it should be recognized that the compression member can include any number of portions, including a single element compression member, where the single member is pre-staked or at least one of the portions of a multi-element compression member is pre-staked to achieve the advantages described above.

What is claimed is:

1. A fitting for coupling fluidic paths, comprising:
a compression nut having a threaded outer surface to engage a threaded bore of a receiving port;
a tube assembly having an outer surface and an end face to contact a sealing surface of the receiving port; and
a compression member pre-staked to the outer surface of the tube assembly at a predetermined distance from the end face and having a tapered surface to engage a surface of the receiving port, the predetermined distance permitting the tube assembly to be inserted into the receiving port so that the end face makes contact with the sealing surface without the tapered surface engaging a surface of the receiving port and so that the threaded outer surface of the compression nut engages the threaded bore of the receiving port.

2. The fitting of claim 1 wherein the compression member comprises a ferrule.

3. The fitting of claim 1 wherein the compression member comprises a two element ferrule.

4. The fitting of claim 1 wherein the tube assembly comprises a tube and a sleeve, the tube being coaxial with and enclosed by the sleeve, a portion of the tube having the end face and extending out from an end of the sleeve.

5. The fitting of claim 1 wherein the tube assembly is made of stainless steel.

6. A method for coupling fluidic paths, comprising:
inserting a tube assembly through a compression nut having a threaded outer surface and through a compression member having a tapered surface;
pre-staking the compression member at an initial position on an outer surface of the tube assembly at a predetermined distance from an endface of the tube assembly;
inserting the tube assembly into a receiving port having a threaded outer bore, an inner bore to receive the tube assembly, a cavity having a tapered surface and extending from an end of the outer bore to a first end of the inner bore, a sealing surface at a second end of the inner bore and a fluid channel extending from the sealing surface to conduct a fluid passing through the tube assembly; and
threading the compression nut into the threaded outer bore of the receiving port so that the compression nut engages the compression member at the initial position and urges the tube into the inner bore so that the endface is in contact with the abutment surface and, on further threading of the compression nut, urges the compression member along the outer surface of the tube assembly from the initial position until the tapered surface of the compression member is in contact with the tapered surface of the cavity.

7. The method of claim 6 wherein the compression member comprises a ferrule.

8. The method of claim 6 wherein the compression member comprises a two element ferrule.

9. The method of claim 6 wherein the tube assembly comprises a tube and a sleeve, the tube being coaxial with and enclosed by the sleeve.

10. The method of claim 9 wherein a portion of the tube having the end face extends out from an end of the sleeve.

11. The method of claim 6 wherein pre-staking the compression member comprises applying a force to secure the compression member at the initial position wherein the force is insufficient to prevent movement of the compression member along the outer surface of the tube assembly while the compression nut is threaded into the outer bore of the receiving port.

12. A fixture for pre-staking a compression member to a tube assembly, the fixture comprising a threaded upper bore, a middle bore, a conical cavity extending between the threaded upper bore and the middle bore, and a lower bore extending from an end of the middle bore opposite to the conical cavity, the middle bore having a length to maintain a predetermined distance from an end face of a tube assembly inserted into the lower bore to a compression member on an outer surface of the tube assembly, wherein rotation of a compression nut having a threaded outer surface engaged with the threaded upper bore applies a controlled force to pre-stake the compression member to maintain the predetermined distance from the end face of the tube assembly to the compression member.
